(19) United States
(12) Patent Application Publication
(10) Pub. No.: US 2022/0245585 A1
(43) Pub. Date: Aug. 4, 2022

(54) SYSTEM AND METHOD FOR GENERATING LAST-MILE DELIVERY ROUTES

(71) Applicant: Walmart Apollo, LLC, Bentonville, AR (US)

(72) Inventors: Chenxin Ma, Belmont, CA (US); Mingang Fu, Palo Alto, CA (US); Ankush Bhargava, Millbrae, CA (US)

(73) Assignee: Walmart Apollo, LLC, Bentonville, AR (US)

(21) Appl. No.: 17/163,197

(22) Filed: Jan. 29, 2021

(51) Int. Cl. G06Q 10/08; G06Q 10/06; G06Q 10/04; G01C 21/34

(52) U.S. Cl. CPC G06Q 10/08355; G06Q 10/06312; G06Q 10/06313; G06Q 10/06315; G01C 21/343; G06Q 10/0832; G06Q 10/047

(57) ABSTRACT

A method including sorting multiple package delivery requests in a descending order based on a respective degree of limitation for a first respective constraint for each of the multiple package delivery requests. In some embodiments, each of the multiple package delivery requests comprises the first respective constraint and a respective destination. In many embodiments, the method further can include generating one or more delivery routes originated from a depot based, at least in part, on the multiple package delivery requests, as sorted, and a respective destination distance for each pair of the multiple package delivery requests. In some embodiments, the method additionally can include generating one or more driving directions based on the one or more delivery routes. Other embodiments are disclosed.

### TECHNICAL FIELD

This disclosure relates generally to systems and/or methods for generating last-mile delivery routes from a depot.

### BACKGROUND

E-Commerce has become an undivided part of our daily life. People nowadays can buy almost everything online and often demand the orders delivered as soon as possible or at a specific time window. In view of the volume of packages to be delivered, which can easily reach hundreds or thousands daily for each store or depot, systems and methods for automatically generating last-mile delivery routes can be desired. In addition, with the increased demand of same-day, 2-hour, or even 1-hour deliveries, it can be desirable that the systems and methods generate the last-mile delivery routes in a time efficient manner.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for generating delivery routes for packages from a depot, according to an embodiment;

FIG. 4 illustrates a flow chart for a method, according to an embodiment;

FIG. 5 shows pseudo code for a method, according to an embodiment; and

FIGS. 6-11 illustrate one or more delivery routes generated by one or more activities of a method, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

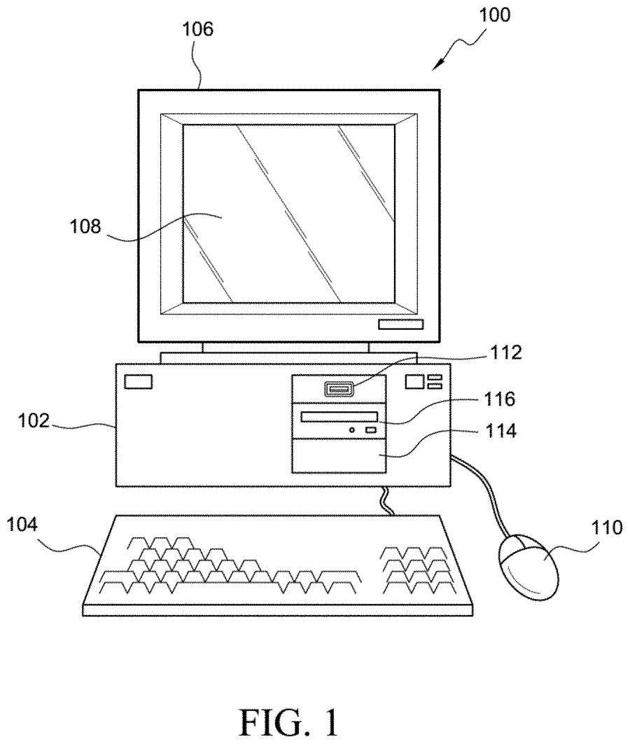

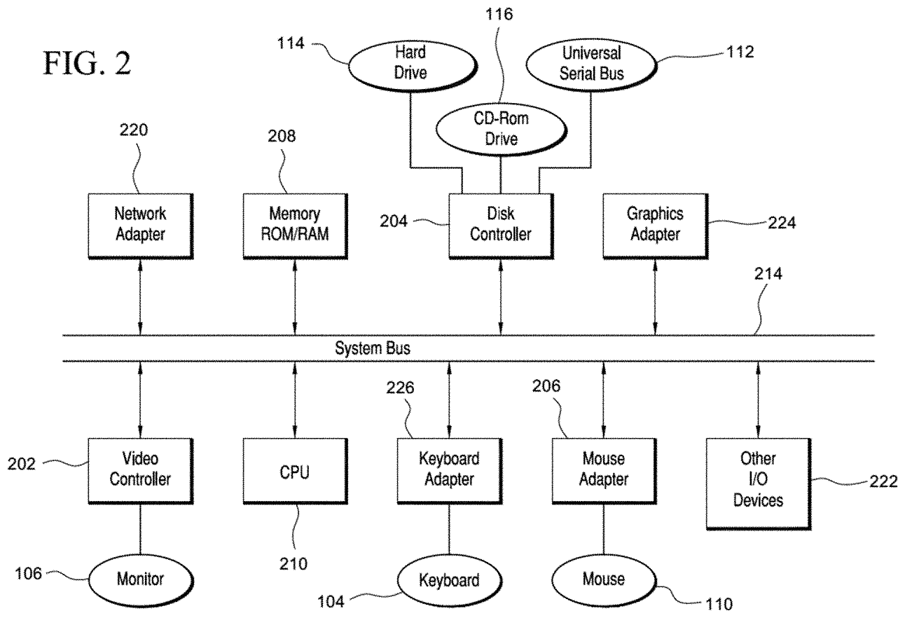

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

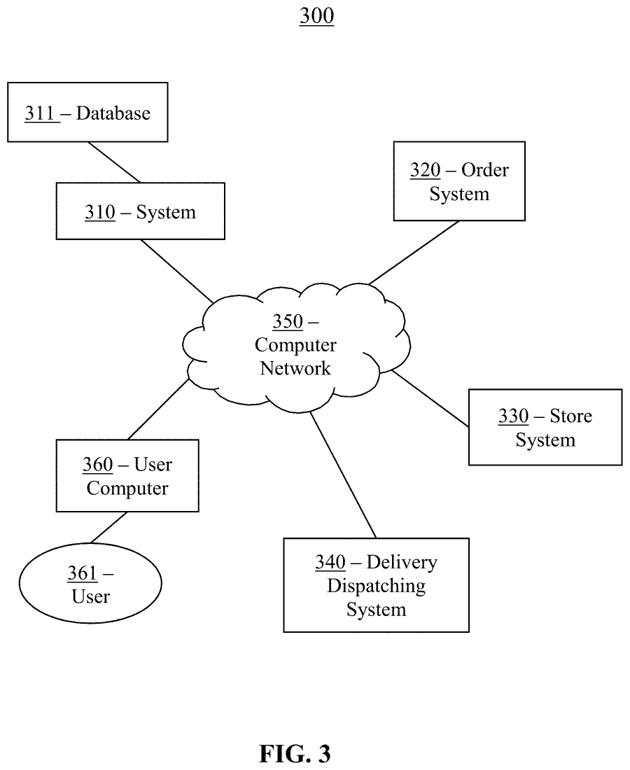

Turning ahead in the drawings, FIG. 3 illustrates a block diagram of a system 300 that can be employed for determining last-mile delivery routes for package delivery requests, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In a number of embodiments, operators and/or administrators (e.g., a user 361) of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, an order system 320, a store system 330, a delivery dispatching system 340, and/or a user computer 360. System 310, order system 320, store system 330, delivery dispatching system 340, and/or user computer 360 can each be a computer system, such as computer system 100 (FIG. 1), as described above, and can each be a single computer, a single server, or a cluster or collection of computers or servers, or a cloud of computers or servers. In another embodiment, a single computer system can host system 310, order system 320, store system 330, delivery dispatching system 340, and/or user computer 360. Additional details regarding system 310, order system 320, store system 330, delivery dispatching system 340, and/or user computer 360 are described herein.

Referring to FIG. 3, in some embodiments, system 310 can be in data communication with order system 320, store system 330, delivery dispatching system 340, and/or user computer 360, using any suitable computer network (e.g., a computer network 350), including the Internet or an internal network that is not open to the public. Communication between system 310, order system 320, store system 330, delivery dispatching system 340, and/or user computer 360 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Meanwhile, in many embodiments, system 310, order system 320, store system 330, delivery dispatching system 340, and/or user computer 360 also can be configured to communicate with and/or include one or more databases (e.g., a database 311). The one or more databases can include a product database that contains information about products, items, or SKUs (stock keeping units), for example, among other data as described herein. The one or more databases also can include a store database that contains information about the locations of the stores, in-house delivery fleets for the stores, store hours, delivery driver shifts, or past deliveries by the in-house delivery fleets, etc. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Still referring to FIG. 3, in a number of embodiments, order system 320 can receive orders from customers, in addition to other suitable activities. In many embodiments, an order can include one or more packages, and the delivery request for each of the one or more packages can be associated with one or more respective constraints. The one or more respective constraints can come from a customer's request or be provided by system 300 and/or order system 320 based on the one or more items in the package. For example, in some embodiments, order system 320 can allow a customer to select an arrival time window, during which the customer plans to receive the package(s) for an order. In another example, a package with groceries further can be required, by law or regulations, to be delivered within a certain time period, e.g., 1 hour, after the package is picked up by a delivery vehicle, unless the delivery vehicle is temperature-controlled.

In some embodiments, order system 320 can include store system 330. In several embodiments, each store system (e.g., 330) can be located in a different physical store. In some embodiments, a physical store can include a depot, warehouse, or fulfillment center that is not open to the public. In many embodiments, the physical stores each can be a brick-and-mortar store that is associated (e.g., operated by a common business entity or entities under common control) with order system 320. In a number of embodiments, a physical store can be a grocery store or a larger store (e.g., a super store) that include a grocery store or grocery department. In other embodiments, a physical store can be a department store or other retail store that does not sell groceries. In some embodiments, each store system (e.g., 330) can be in data communications with system 310 and/or delivery dispatching system 340 for scheduling and dispatching an in-house delivery driver or a third-party carrier driver to deliver packages from a depot or a physical store. In a few embodiments, store system 330 can include system 310 and/or delivery dispatching system 340.

In many embodiments, upon receiving an order with a delivery request from a customer, order system 320 can transmit a package delivery request for a package of the order (or multiple package delivery requests for multiple packages of the order) to system 310 for system 310 to assign a delivery route for the package. The package delivery request can comprise or be associated with a depot (e.g., a physical store) from which the package will be picked up by a delivery driver, a destination where the customer plans to receive the package, an arrival time window during which the package should be dropped off at the destination, the weight of the package, and/or the volume of the package, for example, among other things. In some embodiments, system 310, instead of order system 320, can determine the depot for the package delivery request based on the destination for the package.

In a number of embodiments, system 310 can be employed to automatically design delivery routes from a depot (e.g., a physical store) for multiple package delivery requests. The delivery routes can be generated for the multiple package delivery requests with arrival time windows in a certain period of time, such as an hour, a shift (e.g., morning, afternoon, or evening), or a day. In some embodiments, system 310 can sort the multiple package delivery requests in a descending order based on a respective degree of limitation for a first respective constraint (e.g., the length of the arrival time window) for each of the multiple package delivery requests. In several embodiments, system 310 further can generate one or more delivery routes originated from the depot based, at least in part, on the multiple package delivery requests, as sorted, and a respective destination distance for each pair of the multiple package delivery requests. In certain embodiments, once the delivery routes are determined, system 310 can generate one or more driving directions based on the one or more delivery routes. In a few embodiments, system 310 also can transmit the delivery routes and/or driving directions via the computer network to store system 330 and/or delivery dispatching system 340 to match delivery drivers with the delivery routes.

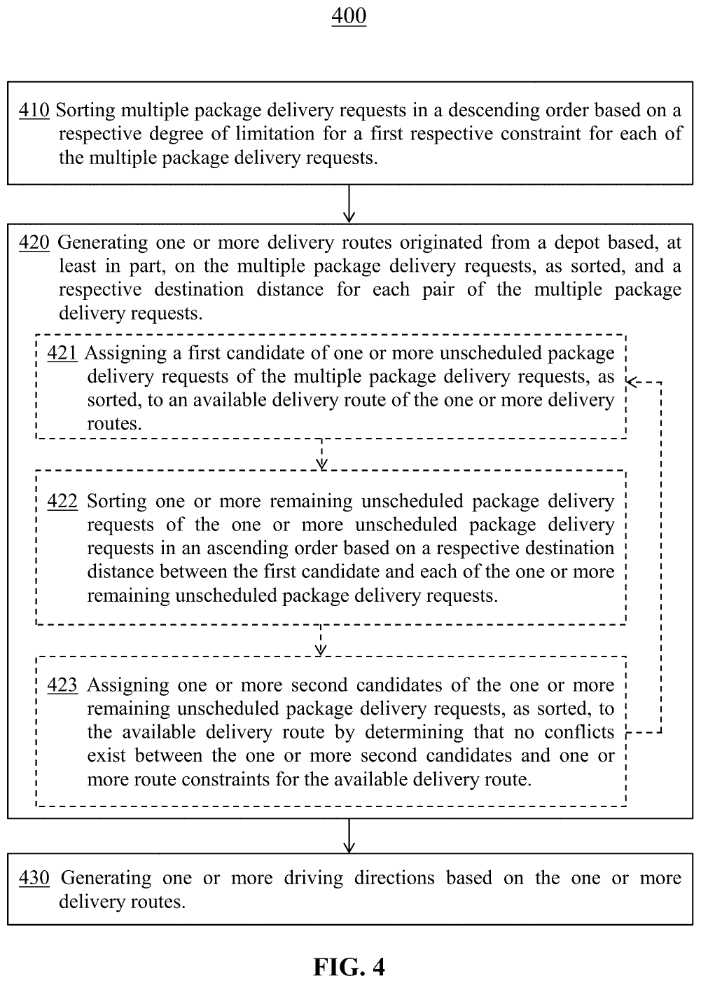

Turning ahead in the drawings, FIG. 4 illustrates a flow chart for a method 400, according to an embodiment. In some embodiments, method 400 can be a method of generating delivery routes for package delivery requests from a depot. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

In some embodiments, method 400 and blocks in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, in many embodiments, method 400 can include a block 410 of sorting multiple package delivery requests in a descending order based at least in part on a respective degree of limitation for a first respective constraint for each of the multiple package delivery requests. In some embodiments, each package delivery request can comprise the first respective constraint and a respective destination. For example, in embodiments where a customer is allowed to choose an arrival time window of various lengths (e.g., 1-hour delivery, same-day delivery, or the morning of a specific date, etc.), and the first respective constraint is the arrival time window, the multiple package delivery requests sorted in a descending order based on the respective degree of limitation for the arrival time window can include the package delivery requests with the shorter arrival time window (i.e., the more limiting first respective constraints) at the front of the list, and those package delivery requests with the longer arrival time window (i.e., the less limiting first respective constraints) at the end of the list.

In a number of embodiments, method 400 further can include a block 420 of generating one or more delivery routes originated from a depot based, at least in part, on the multiple package delivery requests, as sorted, and a respective destination distance for each pair of the multiple package delivery requests. In many embodiments, block 420 can generate the delivery routes further based on other constraints. For example, in some embodiments, block 420 can take into consideration one or more respective second constraints (or route constraints) for each of the delivery routes, such as a respective between-stops idle time constraint, a respective volume constraint, a respective weight constraint, and/or a respective driver shift constraint, among other things.

In a number of embodiments, in the process of generating the delivery routes, block 420 also can consider the first respective constraint for each of one or more already-scheduled package delivery requests for the each of the delivery routes so that adding a package delivery request to a delivery route that includes at least one already-scheduled package delivery request would not result in any conflicts. Conflicts can exist when the delivery route with the package delivery request added can no longer satisfy all of the constraints, including: (a) the respective constraints for each of the package delivery request and the already-scheduled package delivery request, and (b) the respective second constraints (i.e., the route constraints) for the delivery route, etc. In many embodiments, the respective second constraints for a delivery route further can include the first respective constraint and/or other respective constraint(s) for each of the already-scheduled package delivery request(s) of the delivery route.

Moreover, in some embodiments where not all delivery vehicles are the same, block 420 further can generate the delivery routes by assigning a respective delivery vehicle to each of the one or more delivery routes based, at least in part, on a respective cost for the respective delivery vehicle. For example, block 420 can assign the most cost-efficient delivery vehicle in terms of gas mileage to the first delivery route, the potentially longest delivery route, or a delivery route to the farthest destination.

Still referring to FIG. 4, in some embodiments, block 420 can include a block 421 of assigning a first candidate of one or more unscheduled package delivery requests of the multiple package delivery requests, as sorted, to an available delivery route of the one or more delivery routes. In a number of embodiments, the available delivery route can be empty initially (i.e., no package delivery requests or delivery vehicle have been assigned to the available delivery route), and block 421 further can include assigning an available delivery vehicle of the delivery vehicles for the depot to the available delivery route based, at least in part, on a cost for the available delivery vehicle. In some embodiments, after the first candidate is successfully inserted into the available delivery route in block 421, the first candidate can be removed from the one or more unscheduled package delivery requests, and the one or more route constraints for the available delivery route further can comprise the first respective constraint, and any other respective constraint(s), for the first candidate.

In a number of embodiments, block 420 further can include a block 422 of sorting one or more remaining unscheduled package delivery requests of the one or more unscheduled package delivery requests in an ascending order based on a respective destination distance between the first candidate and each of the one or more remaining unscheduled package delivery requests. In some embodiments, block 422 further can include one or more exception detecting steps, such as before sorting the one or more remaining unscheduled package delivery requests, checking if the available delivery route is still available.

In a number of embodiments, block 420 additionally can include a block 423 of assigning one or more second candidates of the one or more remaining unscheduled package delivery requests of the one or more unscheduled package delivery requests, as sorted based on the respective destination distance, to the available delivery route. In some embodiments, block 423 further can include before assigning each of the one or more second candidates to the available delivery route, determining that no conflicts exist between the each of the one or more second candidates and one or more route constraints for the available delivery route. In certain embodiments, block 423 also can include determining an optimal stop sequence for the already-scheduled package delivery request(s) in the available delivery route, including the first candidate, and the one or more second candidates inserted into the available delivery route. The criteria for the optimal stop sequence can include for example, the total mileage, the total delivery time, the between-stops idle time, the dead mileage, and/or the costs for the available delivery route, which can the wage for the delivery driver, the cost for fuel, and/or the costs associated with the delivery vehicle, etc., among other things. In certain embodiments, block 423 can determine the optimal stop sequence by applying any suitable stop-sequence-optimizing algorithm(s), such as greedy algorithm, based at least in part on the respective costs for the available delivery route.

In many embodiments, after the one or more second candidates are successfully inserted into the available delivery route, the one or more second candidates can be removed from the one or more unscheduled package delivery requests. In some embodiments, after assigning the one or more second candidates to the available delivery route in block 423, when (a) the available delivery route is full or none of the one or more remaining unscheduled package delivery requests can be inserted into the available delivery route, and (b) the one or more remaining unscheduled package delivery requests are not empty, block 420 can continue at block 421 for a next available delivery route.

Still referring to FIG. 4, in a number of embodiments, method 400 additionally can include block 430 of generating one or more driving directions based at least in part on the one or more delivery routes. In some embodiments, block 430 can generate the one or more driving directions further based on other information, such as real-time traffic data or historical traffic data. In a few embodiments, block 430 also can transmit, through a computer network, the one or more driving directions directly or indirectly to the depot (e.g., store system 330 (FIG. 3)), a delivery dispatching system (e.g., delivery dispatching system 340 (FIG. 3)), and/or the delivery driver(s) for the one or more delivery routes, via the user interface for the mobile device(s) of the delivery driver(s) (e.g., computer system 100 (FIG. 1)).

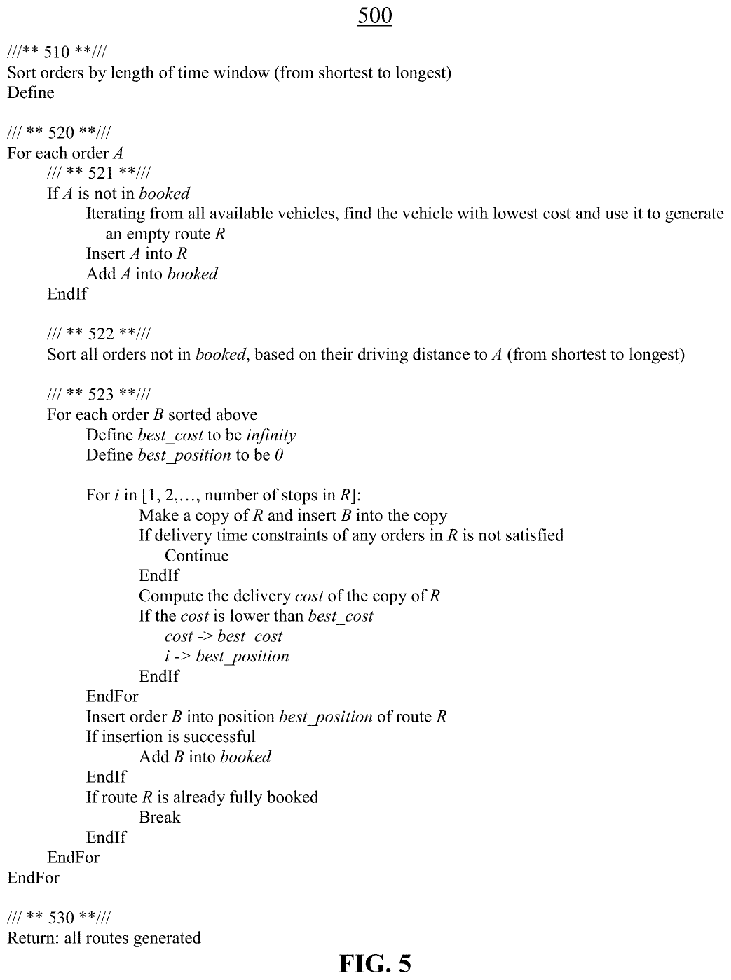

Turning ahead in the drawings, FIG. 5 shows pseudo code for a method 500, according to an embodiment. In some embodiments, method 500 can be a method of generating delivery routes for package delivery requests from a depot. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3) or system 310 (FIG. 3) can be suitable to perform method 500 and/or one or more of the activities of method 500. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

In some embodiments, method 500 and activities/steps in method 500 can include using a distributed network including distributed memory architecture to perform the associated activity. This distributed architecture can reduce the impact on the network and system resources to reduce congestion in bottlenecks while still allowing data to be accessible from a central location.

Referring to FIG. 5, in a number of embodiments, method 500 can include a step 510 for sorting package delivery requests based on a length of a respective time window for each of the package delivery requests. In many embodiments, step 510 can be similar or identical to block 410 (FIG. 4).

In a number of embodiments, method 500 further can include a step 520 for generating one or more delivery routes originated from a depot based, at least in part, on the package delivery requests, as sorted in step 510, a respective destination distance for each pair of the package delivery requests, and/or a respective cost for each of the one or more delivery routes. In many embodiments, step 520 can be similar or identical to block 420 (FIG. 4).

In some embodiments, step 520 also can include a step 521 for assigning a first candidate (e.g., A) of one or more unscheduled package delivery requests (e.g., the package delivery request(s) not in booked) of the multiple package delivery requests, as sorted, to an available delivery route of the one or more delivery routes. In many embodiments, step 521 can be similar or identical to block 421 (FIG. 4). In several embodiments, step 521 can include finding the delivery vehicle with a lowest cost for the available delivery route (e.g., R) for the first candidate (e.g., A).

In a number of embodiments, step 520 further can include a step 522 for sorting one or more remaining unscheduled package delivery requests (e.g., B) of the one or more unscheduled package delivery requests in an ascending order based on a respective destination distance between the first candidate (e.g., A) and each of the one or more remaining unscheduled package delivery requests (e.g., B). In many embodiments, step 522 can be similar or identical to block 422 (FIG. 4).

In a number of embodiments, step 520 additionally can include a step 523 for assigning one or more second candidates of the one or more remaining unscheduled package delivery requests, as sorted, to the available delivery route by determining that no conflicts exist at least between the one or more second candidates and one or more route constraints for the available delivery route. In many embodiments, step 523 can be similar or identical to block 423 (FIG. 4). In some embodiments, step 523 can determine not to assign a second candidate (e.g., B) to the available delivery route when adding the second candidate would result in at least one of one or more packages assigned to the available delivery route, including the already-scheduled package(s) (e.g., the first candidate A) and/or the second candidate, cannot be delivered in time. In a few embodiments, step 523 also can determine that a second candidate (e.g., B) cannot be assigned to the available delivery route when for example, the weight/volume of the second candidate exceeds the remaining weight/volume capacity of the delivery vehicle for the available delivery route.

Further, in some embodiments, step 523 can determine an optimal stop sequence for the packages assigned to the available delivery route, including A and B, by finding the best position for inserting the second candidate B into the already-scheduled package(s) in the available delivery route. In many embodiments, the best position for the to-be-assigned second candidate B is the position that would result in the lowest delivery cost for the available delivery route. In similar or different embodiments, the best position can be determined based at least in part on one or more of: the overall costs, the overall delivery time, or the total idle time, etc.

In a number of embodiments, method 500 also can include a step 530 for returning the delivery routes generated in steps 510 and 520 to the depot (e.g., store system 330 (FIG. 3)), a delivery dispatching system (e.g., delivery dispatching system 340 (FIG. 3)), and/or the delivery driver(s) for the one or more delivery routes, via the user interface for the mobile device(s) of the delivery driver(s) (e.g., computer system 100 (FIG. 1)). In some embodiments, step 530 further can include generating and transmitting driving instructions to the depot (e.g., store system 330 (FIG. 3)), the delivery dispatching system (e.g., delivery dispatching system 340 (FIG. 3)), and/or the delivery driver(s).

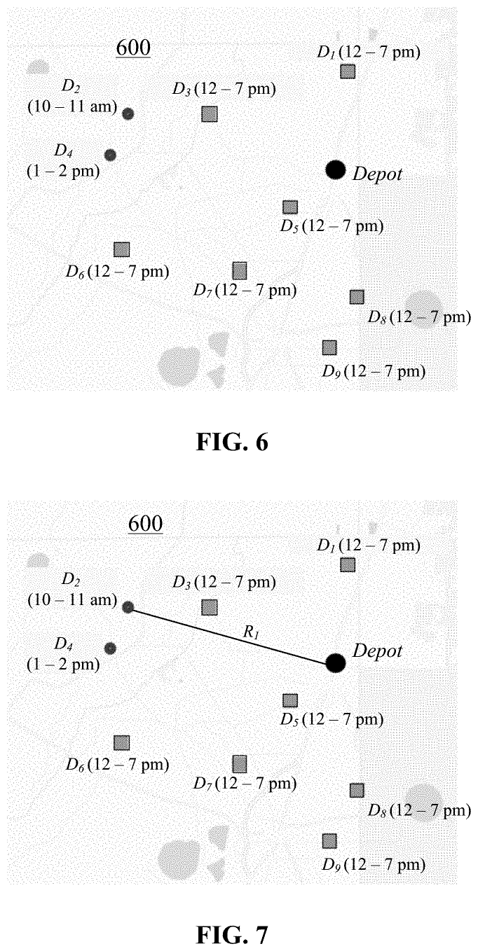

Turning ahead in the drawings, FIGS. 6-11 illustrate one or more delivery routes generated by a method 600, according to an embodiment. In many embodiments, method 600 can comprise one or more procedures, processes, activities, steps, and/or blocks similar or identical to the one or more procedures, processes, activities, steps, and/or blocks of method 400 (FIG. 4) or method 500 (FIG. 5). In many embodiments, system 300 (FIG. 3) or system 310 (FIG. 3) can be suitable to perform method 600 and/or one or more of the procedures, processes, steps, and/or activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 6, an exemplary map shows the locations of a depot (Depot) and the destinations of the multiple package delivery requests for packages to be delivered from Depot for a specific business day. The destinations here are marked with their respective identification and respective arrival time windows in parentheses, e.g., D₁ (12-7 pm), D₂ (10-11 am), etc. Further, in this example, the packages of the package delivery requests are identical in volume and weight, and Depot has unlimited number of delivery vans. Each of the exemplary delivery vans for Depot can be associated with identical constraints, including the constraints for the vehicles as well as the drivers' shifts, such as a maximum capacity of 2 packages, a maximum between-stops idle time of 15 minutes, and a delivery time limit of 1 hour. No delivery routes are assigned yet in FIG. 6.

In many embodiments, method 600 can include a step (not shown in the drawings) that is similar or identical to block 410 (FIG. 4) or step 510 (FIG. 5). In a number of embodiments, the step can include sorting multiple package delivery requests based on a respective length for a respective arrival time window for each of the multiple package delivery requests, with package delivery request with the shortest respective arrival time window at the front of the list. In this example in FIG. 6, the set of all of the package delivery requests (P) initially can be listed as:

P={D₁, D₂, D₃, D₄, D₅, D₆, D₇, D₈, D₉}.

After sorting in the step, in some embodiments, the multiple package delivery requests (P) can become {D₂, D₄, D₁, D₃, D₅, D₆, D₇, D₈, D₉}.

In some embodiments, method 600 further can include a step in FIG. 7 that is similar or identical to block 421 (FIG. 4) or step 521 (FIG. 5). In a number of embodiments, the step in FIG. 7 can include assigning a first candidate of one or more unscheduled package delivery requests of the multiple package delivery requests, as sorted, to an available delivery route of one or more delivery routes. Further, in a number of embodiments, the step in FIG. 7 can include removing the first candidate assigned to the available delivery route from the unscheduled package delivery requests.

In the embodiment in FIGS. 6-11, before the step in FIG. 7 is performed, because none of the multiple package delivery requests in P is scheduled, the set of the one or more unscheduled package delivery requests (Pᵤ) would be equal to P, and the first candidate (C₁) would be D₂. Similarly, because none of the one or more delivery routes (R_{1 . . . n}) are scheduled, the available deliver route (Rₐ) would be the first delivery route (R₁), which is initially empty. In sum, the exemplary variables before the first candidate is assigned to the available delivery route in the step in FIG. 7 can be as follows:

P={D₂, D₄, D₁, D₃, D₅, D₆, D₇, D₈, D₉};

Pᵤ=P={D₂, D₄, D₁, D₃, D₅, D₆, D₇, D₈, D₉};

C₁=D₂; and

Rₐ=R₁={ }.

After C₁ is assigned to the then empty available delivery route Rₐ, in the step in FIG. 7, the step in FIG. 7 further can remove C₁ from the unscheduled package delivery requests (Pᵤ) in the step in FIG. 7. Accordingly, the exemplary variables after the step in FIG. 7 can become as below:

P={D₂, D₄, D₁, D₃, D₅, D₆, D₇, D₈, D₉};

Pᵤ={D₄, D₁, D₃, D₅, D₆, D₇, D₈, D₉};

C₁=D₂; and

Rₐ=R₁={D₂}.

Additionally, in many embodiments, with the first candidate assigned to the available delivery route in the step in FIG. 7, the route constraints of the available delivery route can include the one or more constraints of the first candidate. In this example as shown in FIG. 7, the route constraints of the available delivery route Rₐ=R₁ can include the arrival time window of C₁=D₂ (i.e., 10-11 am), in addition to the one or more route constraints of the delivery vehicle assigned to Rₐ=R₁ (i.e., a maximum capacity of 2 packages, and a delivery time limit of 1 hour, etc., as provided above).

In a number of embodiments, method 600 further can include a step (not shown in the drawings) that is similar or identical to block 422 (FIG. 4) or step 522 (FIG. 3). In a number of embodiments, the step can include sorting one or more remaining unscheduled package delivery requests of the one or more unscheduled package delivery requests in an ascending order based on a respective destination distance between the first candidate and each of the one or more remaining unscheduled package delivery requests. Here, after the one or more remaining unscheduled package delivery requests (Pᵣ) of the one or more unscheduled package delivery requests (Pᵤ) are sorted in the step in an ascending order based on a respective destination distance between the first candidate C₁ and each of the one or more remaining unscheduled package delivery requests in Pᵤ, the exemplary variables can become as below:

P={D₂, D₄, D₁, D₃, D₅, D₆, D₇, D₈, D₉};

Pᵤ={D₄, D₁, D₃, D₅, D₆, D₇, D₈, D₉};

Pᵣ={D₄, D₃, D₆, D₅, D₁, D₇, D₈, D₉};

C₁=D₂; and

Rₐ=R₁={D₂}.

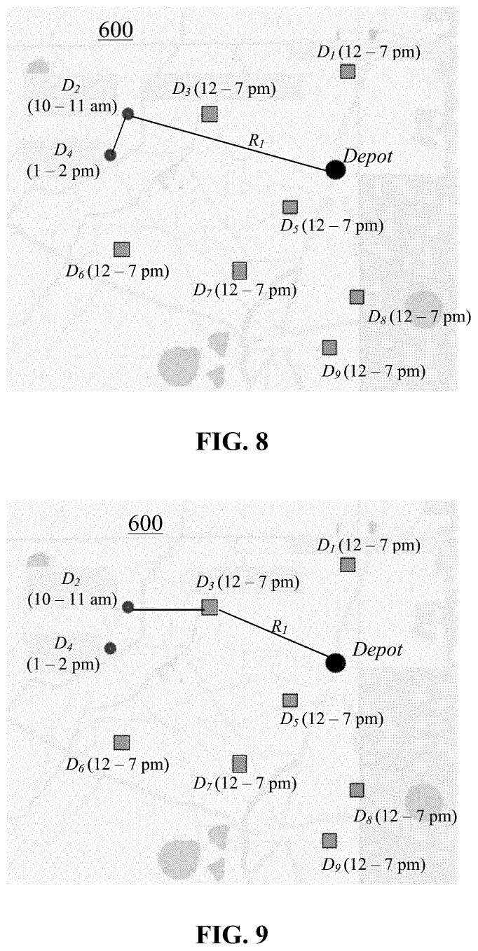

In a number of embodiments, method 600 further can include a step in FIGS. 8 and 9 that is similar or identical to block 423 (FIG. 4) or step 523 (FIG. 5). In a number of embodiments, the step in FIGS. 8 and 9 can include assigning one or more second candidates of the one or more remaining unscheduled package delivery requests, as sorted, to the available delivery route by determining that (a) the available delivery route is not full, and/or (b) no conflicts exist between the one or more second candidates and one or more route constraints for the available delivery route. In this example, as shown in FIGS. 6-11 and Pᵣ above, D₄ is the first one of the one or more second candidates (C₂₋₁=D₄), D₃ is the second one of the one or more second candidates (C₂₋₂=D₃), D₆ is the third one of the one or more second candidates (C₂₋₃=D₆), and so forth. As such, the step in FIGS. 8 and 9 can assign the one or more second candidates (C₂₋₁, C₂₋₂, C₂₋₃ . . . ) one by one to the available delivery route Rₐ.

In the exemplary embodiment, the step in FIGS. 8 and 9 also can determine that the available delivery route Rₐ=R₁={D₂} is not full. Then, C₂₋₁ (i.e., D₄) can be temporarily assigned to the available delivery route Rₐ, as shown in FIG. 8, and the step in FIGS. 8 and 9 can determine whether any conflicts would arise with C₂₋₁ assigned to Rₐ. Here, a conflict can exist between the arrival time window of D₄ (1-2 pm) and at least one of the route constraints, such as (a) a maximum between-stops idle time of Rₐ (i.e., 15 minutes here) when the idle time between D₂ and D₄ would be at least 2 hours; and/or (b) a delivery time window of Rₐ (10-11 am) when Rₐ includes at least the constraints of D₂ (i.e., the arrival time window is 10-11 am) and the delivery van for Rₐ (i.e., the delivery time limit is an hour), etc. As such, C₂₋₁ cannot be successfully inserted into Rₐ, and the step in FIGS. 8 and 9 can proceed with the next second candidate of the one or more second candidates because now that D₄ is not assigned to the available delivery route Rₐ, Rₐ still is not full.

Next, when C₂₋₂ (i.e., D₃) is temporarily assigned to the available delivery route Rₐ, the step in FIGS. 8 and 9 can determine that there is no conflict between C₂₋₂ and one or more route constraints for the available delivery route Rₐ. Accordingly, C₂₋₂ (i.e., D₃) is successfully assigned to the available delivery route Rₐ in the step in FIGS. 8 and 9, and the exemplary variables can become:

P={D₂, D₄, D₁, D₃, D₅, D₆, D₇, D₈, D₉};

Pᵤ={D₄, D₁, D₅, D₆, D₇, D₈, D₉};

Pᵣ={D₄, D₆, D₅, D₁, D₇, D₈, D₉};

C₁=D₂; and

Rₐ=R₁={D₂, D₃}.

In many embodiments, the step in FIGS. 8 and 9 also can include determining an optimal stop sequence for the already-scheduled package delivery request(s) in the available delivery route, including the first candidate, and the one or more second candidates in the available delivery route. After D₃ is assigned to the available delivery route Rₐ, and the optimal stop sequence is determined for D₂ and D₃ in Rₐ in the step in FIGS. 8 and 9, as shown in FIG. 9, method 600 or the step in FIGS. 8 and 9 can determine that the available delivery route Rₐ is full, and method 600 can repeat from the step in FIG. 7, including assigning the next first candidate (C₁) of the one or more unscheduled package delivery requests (Pᵤ), as sorted, to the next available delivery route (Rₐ), etc.

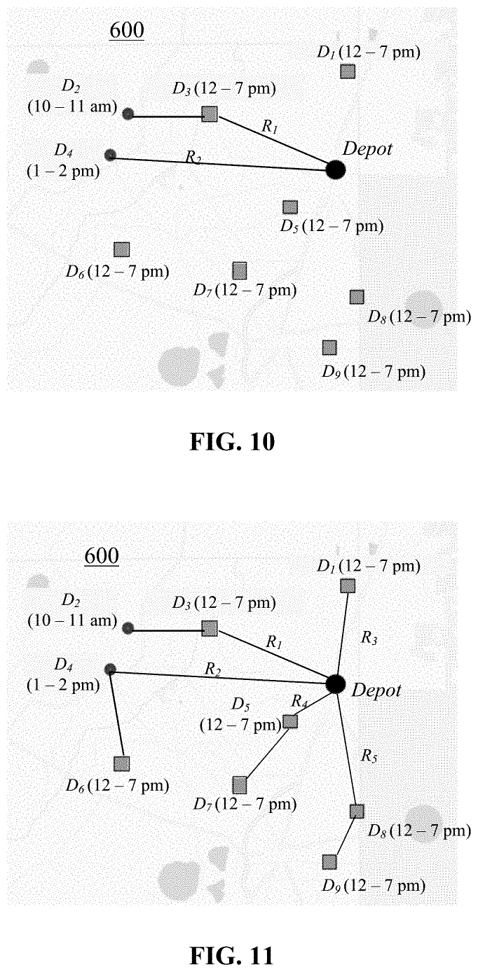

Back to the step in FIG. 7, the first candidate C₁ would become D₄ after D₂ and D₃ are removed from the one or more unscheduled delivery requests Pᵤ. After the step in FIG. 7 assigns the first candidate C₁=D₄ to the new available delivery route Rₐ=R₂, as shown in FIG. 10, the exemplary variables would become as below:

P={D₂, D₄, D₁, D₃, D₅, D₆, D₇, D₈, D₉};

Pᵤ={D₁, D₅, D₆, D₇, D₈, D₉};

Pᵣ=Pᵤ={D₁, D₅, D₆, D₇, D₈, D₉};

R₁={D₃, D₂};

C₁=D₄; and

Rₐ=R₂={D₄}.

From here, in many embodiments, the step in FIG. 10 and the steps in FIG. 11 can follow the step in FIG. 7, to fill the remaining capacity of the available delivery route, and method 600 can repeat the aforementioned steps, including the steps in FIGS. 7, 8, and 9, until each of the multiple package delivery requests is successfully assigned to a respective delivery route, as shown in FIG. 11.

Finally, in a number of embodiments, method 600 also can include another step (not shown in the drawings) that is similar or identical to block 430 (FIG. 3) or step 530 (FIG. 5). In many embodiments, the step can include providing the delivery routes generated here and/or driving directions through a computer network (e.g., computer network 350 (FIG. 3)), directly or indirectly, to the depot (e.g., store system 330 (FIG. 3)), a delivery dispatching system (e.g., delivery dispatching system 340 (FIG. 3)), and/or the delivery drivers as guidance for the depot and the drivers to perform the last-mile deliveries.

In many embodiments, the techniques described herein can provide a practical application and several technological improvements. In some embodiments, the techniques described herein can provide for automatically generating and optimizing delivery routes while taking into consideration the various constraints of the packages and/or delivery vehicles (including the constraints for the delivery drivers and/or store policies). These techniques described herein can provide a significant improvement over conventional approaches of assuming that all packages are equal.

In many embodiments, the techniques described herein can provide several technological improvements. In some embodiments, the techniques described herein can provide a system and/or a method for generating and optimizing delivery routes for package delivery requests from a depot in an easier and more efficient way, compared to other known systems/methods, such as shortest path algorithms, stimulated annealing, large neighborhood search, etc. In a number of embodiments, the system/method can significantly reduce the complexity of the system/method by starting with assigning the delivery routes for the packages with the most limiting constraint(s) (e.g., the packages with the shortest respective arrival time periods). For example, in some embodiments, the system/method can result in at least 9% or up to 30% reduction in computing time, without sacrificing (sometime even with improvement in) the average cost and/or miles per order.

In many embodiments, the techniques described herein can be used continuously at a scale that cannot be handled using manual techniques. For example, the number of packages to be delivered from a depot can be over thousands per day, and the delivery routes, as well as loads/capacities, for delivery vehicles that comply with all the constraints in time and/or load capacity can be generated in real-time or near-real-time, such as less than 10-30 minutes, or any time period between a delivery cutoff time and a time for the preparation of the next pickup time.

In a number of embodiments, the techniques described herein can solve a technical problem that arises only within the realm of computer networks, as online ordering do not exist outside the realm of computer networks. Moreover, the techniques described herein can solve a technical problem that cannot be solved outside the context of computer networks. Specifically, the techniques described herein cannot be used outside the context of computer networks, in view of a lack of data.

Various embodiments can include a system including one or more processors and one or more non-transitory computer-readable media storing computing instructions configured to run on the one more processors and perform certain acts. The acts can include sorting multiple package delivery requests in a descending order based on a respective degree of limitation for a first respective constraint for each of the multiple package delivery requests. In many embodiments, each of the multiple package delivery requests can comprise the first respective constraint and a respective destination. The acts further can include generating one or more delivery routes originated from a depot based, at least in part, on the multiple package delivery requests, as sorted, and a respective destination distance for each pair of the multiple package delivery requests. The acts also can include generating one or more driving directions based on the one or more delivery routes.

In many embodiments, the first respective constraint for each of the package delivery requests can comprise a length of a respective arrival time window for the each of the multiple package delivery requests. In a number of embodiments, each of the one or more delivery routes can be associated with one or more respective second constraints. In several embodiments, the one or more respective second constraints for each of the delivery routes further can comprise at least one or more of: (a) a respective between-stops idle time constraint; (b) a respective volume constraint; (c) a respective weight constraint; (d) a respective driver shift constraint; and/or (e) the first respective constraint for each of one or more already-scheduled package delivery requests for the each of the delivery routes. In some embodiments, the multiple package delivery requests can comprise the one or more already-scheduled package delivery requests for the each of the delivery routes. In a number of embodiments, generating the one or more delivery routes further can comprise assigning a respective delivery vehicle to each of the one or more delivery routes based, at least in part, on a respective cost for the respective delivery vehicle.

In many embodiments, generating the one or more delivery routes further can comprises: (a) assigning a first candidate of one or more unscheduled package delivery requests of the multiple package delivery requests, as sorted, to an available delivery route of the one or more delivery routes; (b) sorting one or more remaining unscheduled package delivery requests of the one or more unscheduled package delivery requests in an ascending order based on a respective destination distance between the first candidate and each of the one or more remaining unscheduled package delivery requests; and/or (c) assigning one or more second candidates of the one or more remaining unscheduled package delivery requests, as sorted, to the available delivery route by determining that no conflicts exist between the one or more second candidates and one or more route constraints for the available delivery route. In certain embodiments, assigning the first candidate to the available delivery route further can comprise determining that no conflicts exist at least between the first candidate and the one or more route constraints for the available delivery route.

In a number of embodiments, after assigning the first candidate to the available delivery route, the one or more route constraints for the available delivery route further can comprise the first respective constraint for the first candidate. In some embodiments, determining the one or more second candidates for the available delivery route further can comprise determining an optimal stop sequence for the one or more second candidates and the already-scheduled package delivery requests (including at least the first candidate) in the available delivery route. In certain embodiments, determining the optimal stop sequence further can comprise applying a greedy algorithm.

A number of embodiments can include a method being implemented via execution of computing instructions configured to run at one or more processors and stored at one or more non-transitory computer-readable media. The method can include sorting multiple package delivery requests in a descending order based on a respective degree of limitation for a first respective constraint for each of the multiple package delivery requests, which can comprise the first respective constraint and a respective destination. The method also can include generating one or more delivery routes originated from a depot based, at least in part, on the multiple package delivery requests, as sorted, and a respective destination distance for each pair of the multiple package delivery requests. The method additionally can include generating one or more driving directions based on the one or more delivery routes. In some embodiments, the method additionally can include one or more procedures, processes, and/or activities of method 400 (FIG. 4), method 500 (FIG. 5), and/or method 600 (FIG. 6) as described above.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although generating one or more delivery routes for multiple package delivery requests has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, and/or activities of FIGS. 4-11 may include different procedures, processes, and/or activities and be performed by many different modules, in many different orders. As another example, one or more of the procedures, processes, and/or activities of one of FIGS. 4-11 can be performed in another one of FIGS. 4-11.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processors; and
one or more non-transitory computer-readable media storing computing instructions configured to run on the one or more processors and perform:
sorting multiple package delivery requests in a descending order based on a respective degree of limitation for a first respective constraint for each of the multiple package delivery requests, wherein:
each of the multiple package delivery requests comprises the first respective constraint and a respective destination;
the first respective constraint is associated with a respective time window for the each of the multiple package delivery requests; and
the respective degree of limitation for the first respective constraint is in an inverse relationship with a length of the respective time window associated with the first respective constraint;
generating one or more delivery routes originated from a depot based, at least in part, on the multiple package delivery requests, as sorted, and a respective destination distance for each pair of the multiple package delivery requests;
generating one or more driving directions based on the one or more delivery routes and real-time traffic data; and
transmitting, through a computer network, each of the one or more driving directions to be displayed on a respective user interface for a respective mobile device of a respective delivery driver.

2. The system in claim 1, wherein:
the first respective constraint for each of the package delivery requests comprises the length of the respective time window for the each of the multiple package delivery requests.

3. The system in claim 1, wherein:
each of the one or more delivery routes is associated with one or more respective second constraints.

4. The system in claim 3, wherein:
the one or more respective second constraints for each of the delivery routes further comprise one or more of:
a respective between-stops idle time constraint;
a respective volume constraint;
a respective weight constraint;
a respective driver shift constraint; or
the first respective constraint for each of one or more already-scheduled package delivery requests for the each of the delivery routes; and
the multiple package delivery requests comprise the one or more already-scheduled package delivery requests for the each of the delivery routes.

5. The system in claim 1, wherein:
generating the one or more delivery routes further comprises assigning a respective delivery vehicle to each of the one or more delivery routes based, at least in part, on a respective cost for the respective delivery vehicle.

6. The system in claim 1, wherein:
generating the one or more delivery routes further comprises:
assigning a first candidate of one or more unscheduled package delivery requests of the multiple package delivery requests, as sorted, to an available delivery route of the one or more delivery routes;
sorting one or more remaining unscheduled package delivery requests of the one or more unscheduled package delivery requests in an ascending order based on a respective destination distance between the first candidate and each of the one or more remaining unscheduled package delivery requests; and
assigning one or more second candidates of the one or more remaining unscheduled package delivery requests, as sorted, to the available delivery route by determining that no conflicts exist between the one or more second candidates and one or more route constraints for the available delivery route.

7. The system in claim 6, wherein:
assigning the first candidate to the available delivery route further comprises determining that no conflicts exist at least between the first candidate and the one or more route constraints for the available delivery route.

8. The system in claim 6, wherein:
after assigning the first candidate to the available delivery route, the one or more route constraints for the available delivery route further comprise the first respective constraint for the first candidate.

9. The system in claim 6, wherein:
determining the one or more second candidates for the available delivery route further comprises determining an optimal stop sequence for at least the first candidate and the one or more second candidates in the available delivery route.

10. The system in claim 9, wherein:
determining the optimal stop sequence further comprises applying a greedy algorithm.

11. A method being implemented via execution of computing instructions configured to run at one or more processors and stored at one or more non-transitory computer-readable media, the method comprising:
sorting multiple package delivery requests in a descending order based on a respective degree of limitation for a first respective constraint for each of the multiple package delivery requests, wherein:
each of the multiple package delivery requests comprises the first respective constraint and a respective destination;
the first respective constraint is associated with a respective time window for the each of the multiple package delivery requests; and
the respective degree of limitation for the first respective constraint is in an inverse relationship with a length of the respective time window associated with the first respective constraint;
generating one or more delivery routes originated from a depot based, at least in part, on the multiple package delivery requests, as sorted, and a respective destination distance for each pair of the multiple package delivery requests;
generating one or more driving directions based on the one or more delivery routes and real-time traffic data; and
transmitting, through a computer network, each of the one or more driving directions to be displayed on a respective user interface for a respective mobile device of a respective delivery driver.

12. The method in claim 11, wherein:
the first respective constraint for each of the package delivery requests comprises the length of the respective time window for the each of the multiple package delivery requests.

13. The method in claim 11, wherein:
each of the one or more delivery routes is associated with one or more respective second constraints.

14. The method in claim 13, wherein:
the one or more respective second constraints for each of the delivery routes further comprise one or more of:
a respective between-stops idle time constraint;
a respective volume constraint;
a respective weight constraint;
a respective driver shift constraint; or
the first respective constraint for each of one or more already-scheduled package delivery requests for the each of the delivery routes; and
the multiple package delivery requests comprise the one or more already-scheduled package delivery requests for the each of the delivery routes.

15. The method in claim 11, wherein:
generating the one or more delivery routes further comprises assigning a respective delivery vehicle to each of the one or more delivery routes based, at least in part, on a respective cost for the respective delivery vehicle.

16. The method in claim 11, wherein:
generating the one or more delivery routes further comprises:
assigning a first candidate of one or more unscheduled package delivery requests of the multiple package delivery requests, as sorted, to an available delivery route of the one or more delivery routes;
sorting one or more remaining unscheduled package delivery requests of the one or more unscheduled package delivery requests in an ascending order based on a respective destination distance between the first candidate and each of the one or more remaining unscheduled package delivery requests; and
assigning one or more second candidates of the one or more remaining unscheduled package delivery requests, as sorted, to the available delivery route upon determining that no conflicts exist between the one or more second candidates and one or more route constraints for the available delivery route.

17. The method in claim 16, wherein:
assigning the first candidate to the available delivery route further comprises determining that no conflicts exist at least between the first candidate and the one or more route constraints for the available delivery route.

18. The method in claim 16, wherein:
after assigning the first candidate to the available delivery route, the one or more route constraints for the available delivery route further comprise the first respective constraint for the first candidate.

19. The method in claim 16, wherein:
generating the one or more delivery routes further comprises determining an optimal stop sequence for at least the first candidate and the one or more second candidates in the available delivery route.

20. The method in claim 19, wherein:
determining the optimal stop sequence further comprises applying a greedy algorithm.
